(19) United States
(12) Patent Application Publication
(10) Pub. No.: US 2017/0268691 A1
(43) Pub. Date: Sep. 21, 2017

(54) Magnetic Attachment System Having a Multi-Pole Magnetic Structure and Pole Pieces

(71) Applicant: Correlated Magnetics Research, LLC, Huntsville, AL (US)

(72) Inventors: Larry W. Fullerton, New Hope, AL (US); Mark D. Roberts, Huntsville, AL (US); Wesley R. Swift, Huntsville, AL (US)

(73) Assignee: Correlated Magnetics Research, LLC, Huntsville, AL (US)

(21) Appl. No.: 15/611,544

(22) Filed: Jun. 1, 2017

Related U.S. Application Data
(63) Continuation-in-part of application No. 15/352,135, filed on Nov. 15, 2016.
Application No. 15/352,135 is a continuation of application No. 15/188,760, filed on Jun. 21, 2016.
Application No. 15/188,760 is a continuation of application No. 14/472,945, filed on Aug. 29, 2014, now Pat. No. 9,371,923.
Application No. 14/472,945 is a continuation-in-part of application No. 14/198,226, filed on Mar. 5, 2014, now abandoned.
Application No. 14/198,226 is a continuation-in-part of application No. 14/103,760, filed on Dec. 11, 2013, now Pat. No. 9,202,616.
Application No. 14/103,760 is a continuation-in-part of application No. 13/779,611, filed on Feb. 27, 2013, now Pat. No. 9,202,615.
Application No. 14/103,760 is a continuation-in-part of application No. 14/066,426, filed on Oct. 29, 2013, now Pat. No. 8,957,751.
Application No. 14/066,426 is a continuation of application No. 13/374,074, filed on Dec. 9, 2011, now Pat. No. 8,576,036.
Application No. 14/103,760 is a continuation-in-part of application No. 14/086,924, filed on Nov. 21, 2013, now Pat. No. 8,779,879.
Application No. 14/086,924 is a continuation-in-part of application No. 14/035,818, filed on Sep. 24, 2013, now Pat. No. 8,872,608.
Application No. 14/035,818 is a continuation-in-part of application No. 13/959,649, filed on Aug. 5, 2013, now Pat. No. 8,692,637.
Application No. 13/959,649 is a continuation-in-part of application No. 13/759,695, filed on Feb. 5, 2013, now Pat. No. 8,502,630.
Application No. 13/759,695 is a continuation of application No. 13/481,554, filed on May 25, 2012, now Pat. No. 8,368,495.
Application No. 13/481,554 is a continuation-in-part of application No. 13/351,203, filed on Jan. 16, 2012, now Pat. No. 8,314,671.
Application No. 13/351,203 is a continuation of application No. 13/157,975, filed on Jun. 10, 2011, now Pat. No. 8,098,122.
Application No. 13/157,975 is a continuation of application No. 12/952,391, filed on Nov. 23, 2010, now Pat. No. 7,961,069.
Application No. 12/952,391 is a continuation of application No. 12/478,911, filed on Jun. 5, 2009, now Pat. No. 7,843,295.
Application No. 12/478,911 is a continuation of application No. 12/478,950, filed on Jun. 5, 2009, now Pat. No. 7,843,296.
Application No. 12/478,950 is a continuation of application No. 12/478,969, filed on Jun. 5, 2009, now Pat. No. 7,843,297.
Application No. 12/478,969 is a continuation of application No. 12/479,013, filed on Jun. 5, 2009, now Pat. No. 7,839,247.
Application No. 12/478,950 is a continuation-in-part of application No. 12/476,952, filed on Jun. 2, 2009, now Pat. No. 8,179,219.
Application No. 12/478,911 is a continuation-in-part of application No. 12/476,952, filed on Jun. 2, 2009, now Pat. No. 8,179,219.
Application No. 12/478,969 is a continuation-in-part of application No. 12/476,952, filed on Jun. 2, 2009, now Pat. No. 8,179,219.
Application No. 12/479,013 is a continuation-in-part of application No. 12/476,952, filed on Jun. 2, 2009, now Pat. No. 8,179,219.
Application No. 12/476,952 is a continuation-in-part of application No. 12/322,561, filed on Feb. 4, 2009, now Pat. No. 8,115,581.
Application No. 12/322,561 is a continuation-in-part of application No. 12/358,423, filed on Jan. 23, 2009, now Pat. No. 7,868,721.
Application No. 14/103,760 is a continuation-in-part of application No. 13/918,921, filed on Jun. 15, 2013, now Pat. No. 8,841,981.
Application No. 13/918,921 is a continuation of application No. 13/629,879, filed on Sep. 28, 2012, now Pat. No. 8,514,046.
Application No. 13/629,879 is a continuation of application No. 13/426,909, filed on Mar. 22, 2012, now Pat. No. 8,279,032.
Application No. 13/426,909 is a continuation-in-part of application No. 13/179,759, filed on Jul. 11, 2011, now Pat. No. 8,174,347.
Application No. 14/103,760 is a continuation-in-part of application No. 14/045,756, filed on Oct. 3, 2013, now Pat. No. 8,810,348.
Application No. 14/045,756 is a continuation-in-part of application No. 13/240,335, filed on Sep. 22, 2011, now Pat. No. 8,648,681.
Application No. 13/240,335 is a continuation-in-part of application No. 12/476,952, filed on Jun. 2, 2009, now Pat. No. 8,179,219.
Application No. 12/476,952 is a continuation-in-part of application No. 12/895,589, filed on Sep. 30, 2010, now Pat. No. 8,760,250.
Application No. 12/895,589 is a continuation-in-part of application No. 12/476,952, filed on Jun. 2, 2009, now Pat. No. 8,179,219.
Application No. 14/045,756 is a continuation-in-part of application No. 13/246,584, filed on Sep. 27, 2011, now Pat. No. 8,760,251.
Application No. 13/246,584 is a continuation-in-part of application No. 15/005,453, filed on Jan. 25, 2016.
Application No. 15/005,453 is a continuation-in-part of application No. 14/258,723, filed on Apr. 22, 2014, now Pat. No. 8,917,154.
Application No. 14/258,723 is a continuation-in-part of application No. 14/103,699, filed on Dec. 11, 2013, now Pat. No. 8,937,521.
Application No. 14/103,699 is a continuation-in-part of application No. 13/960,651, filed on Aug. 6, 2013, now abandoned.
(60) Provisional application No. 61/871,689, filed on Aug. 29, 2013.
(60) Provisional application No. 61/794,427, filed on Mar. 15, 2013.
(60) Provisional application No. 61/798,233, filed on Mar. 15, 2013.
(60) Provisional application No. 61/798,453, filed on Mar. 15, 2013.
(60) Provisional application No. 61/799,507, filed on Mar. 15, 2013.
(60) Provisional application No. 61/800,377, filed on Mar. 15, 2013.
(60) Provisional application No. 61/735,460, filed on Dec. 10, 2012.
(60) Provisional application No. 61/640,979, filed on May 1, 2012.
(60) Provisional application No. 61/640,979, filed on May 1, 2012.
(60) Provisional application No. 61/604,376, filed on Feb. 28, 2012.
(60) Provisional application No. 61/459,994, filed on Dec. 22, 2010.
(60) Provisional application No. 61/796,863, filed on Nov. 21, 2012.
(60) Provisional application No. 61/744,342, filed on Sep. 24, 2012.
(60) Provisional application No. 61/519,664, filed on May 25, 2011.
(60) Provisional application No. 61/465,810, filed on Mar. 24, 2011.
(60) Provisional application No. 61/744,864, filed on Oct. 4, 2012.
(60) Provisional application No. 61/403,814, filed on Sep. 22, 2010.
(60) Provisional application No. 61/462,715, filed on Feb. 7, 2011.
(60) Provisional application No. 61/277,214, filed on Sep. 22, 2009.
(60) Provisional application No. 61/277,900, filed on Sep. 30, 2009.
(60) Provisional application No. 61/278,767, filed on Oct. 9, 2009.
(60) Provisional application No. 61/279,094, filed on Oct. 16, 2009.
(60) Provisional application No. 61/281,160, filed on Nov. 13, 2009.
(60) Provisional application No. 61/283,780, filed on Dec. 9, 2009.
(60) Provisional application No. 61/284,385, filed on Dec. 17, 2009.
(60) Provisional application No. 61/342,988, filed on Apr. 22, 2010.
(60) Provisional application No. 61/404,147, filed on Sep. 27, 2010.
(60) Provisional application No. 61/852,431, filed on Mar. 15, 2013.

(51) Int. Cl. F16K 31/08; F16K 11/14; H01F 7/02

(52) U.S. Cl. CPC F16K 31/088; H01F 7/021; F16K 11/14

(57) ABSTRACT

An attachment system comprises an attachment assembly having a side with an exposed surface. A magnetic structure comprises a plurality of assembly field emission sources having positions and polarities relating to an attachment spatial force function. A plurality of assembly pole pieces are coupled to the magnetic structure such that a spatial spacing is created between the magnetic structure and the side. Each assembly pole piece is coupled to a corresponding one of the plurality of assembly field emission sources for directing magnetic flux. An attachment target attaches to the exposed surface based on the attachment spatial force function. The attachment target comprises a plurality of target field emission sources having positions and polarities relating to the attachment spatial force. The attachment spatial force function is in accordance with a code and corresponds to the relative alignment of the plurality of assembly field emission sources and the plurality of target field emission sources to each other.

### FIELD OF THE INVENTION

The present invention relates generally to magnetism and more particularly to a magnetic attachment system.

### BACKGROUND OF THE INVENTION

It is known to direct magnetic flux, for example, those created by discrete magnets or electromagnetic devices, for attachment purposes. Pole pieces are known structures composed of material of high magnetic permeability, such as iron or steel, that serve to direct magnetic flux. In known arrangements, a pole piece attaches to and extends a pole of a magnet directing the magnetic flux into locations or configurations where it is difficult to place or use the magnet by itself.

A wide variety of magnetic attachment systems are known for attaching objects to each other via magnetic attachment forces. However, the strength of the attachment forces are directly related to the strength of the created magnetic fields in the attachment system. In certain applications, however, the strength of the magnetic fields could adversely impact surrounding objects, devices or components. The magnetic fields associated with these magnets can, for example, de-magnetize or otherwise interfere with credit cards, radio frequency antennas, identification badges, etc. As a result, ambient magnetic field exposure is of concern when using magnetic attachment systems.

One attachment system that addresses ambient magnetic field exposure is described in U.S. Pat. No. 8,143,982 for attaching a cover to a tablet computer. This prior art uses a magnet and spring assembly located within the tablet to control the tablet case magnets with associated fasteners and covers. The magnet and spring assembly is located within the tablet in such a way that when the magnetic tablet cover is not present, the case springs pull the case magnets away from the surface of the tablet, thereby reducing the intensity of the magnetic field surrounding the tablet. When the magnetic cover is brought in proximity of the tablet, the force of attraction between the magnet in the cover and the magnets in the tablet overcome exerted spring forces, bringing the tablet magnet close to the surface of the tablet. However, this magnetic attachment system is complex requiring moving parts.

Therefore, there exists a need for simplified magnetic attachment system that reduces ambient magnetic field exposure.

### BRIEF DESCRIPTION OF THE DRAWINGS

FIG. 1 depict an exploded view of a magnetic attachment system in accordance with one aspect of the invention.

FIG. 2 depicts the attachment of a magnetic structure to an attachment target using the magnetic attachment system of FIG. 1.

FIG. 3 shows the peak attachment spatial force and off-peak spatial forces produced by the magnetic attachment system of FIG. 1.

FIGS. 4A-4B show the impact of shunt plate on magnetic fields of a pair of adjacent magnetic sources.

FIGS. 5A-5B shows an application of the magnetic attachment system of FIG. 1 for attaching a tablet computer to a tablet cover.

FIGS. 6A-6B show two embodiments of the magnetic attachment device in which the pole pieces are shaped to fit within the case of the tablet computer.

FIGS. 7A-7C show the magnetic structure in one embodiment of the attachment system of the invention using a printed magnetic structure.

FIGS. 8A-8B depict layering pole pieces on top of the magnetic attachment system according to one embodiment of the present invention.

### SUMMARY

Briefly, according to one aspect of the present invention the present invention, an attachment system comprises an attachment assembly having a side with an exposed surface. A magnetic structure comprises a plurality of assembly field emission sources having positions and polarities relating to an attachment spatial force function. A plurality of assembly pole pieces are coupled to the magnetic structure such that a spatial spacing is created between the magnetic structure and the side. Each assembly pole piece is coupled to a corresponding one of the plurality of assembly field emission sources for directing magnetic flux. An attachment target attaches to the exposed surface based on the attachment spatial force function. The attachment target comprises a plurality of target field emission sources having positions and polarities relating to the attachment spatial force. The attachment spatial force function is in accordance with a code and corresponds to the relative alignment of the plurality of assembly field emission sources and the plurality of target field emission sources to each other.

According to some of the more detailed feature of the invention, at least one of the plurality of assembly field emission sources or the plurality of target field emission sources comprise discrete magnets. Alternatively, at least one of the plurality of assembly field emission sources or the plurality of target field emission sources comprise printed magnets.

According to other more detailed features of the invention, the plurality of assembly field emission sources have opposing sides, wherein the plurality of assembly pole pieces are coupled to one side and a shunt plate is coupled to the other side.

According to still other more detailed features of the invention, the attachment target comprises a plurality of target pole pieces. Each target pole piece is coupled to a corresponding one of the plurality of target field emission sources for directing magnetic flux. At least one of the plurality of assembly pole pieces or the plurality of target pole pieces can comprise multiple layers. Each layer comprises a plurality of assembly pole pieces.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

Certain described embodiments may relate, by way of example but not limitation, to systems and/or apparatuses comprising magnetic structures, magnetic and non-magnetic materials, methods for using magnetic structures, magnetic structures produced via magnetic printing, magnetic structures comprising arrays of discrete magnetic elements, combinations thereof, and so forth. Example realizations for such embodiments may be facilitated, at least in part, by the use of an emerging, revolutionary technology that may be termed correlated magnetics. This revolutionary technology referred to herein as correlated magnetics was first fully described and enabled in the co-assigned U.S. Pat. No. 7,800,471 issued on Sep. 21, 2010, and entitled “A Field Emission System and Method”. The contents of this document are hereby incorporated herein by reference. A second generation of a correlated magnetic technology is described and enabled in the co-assigned U.S. Pat. No. 7,868,721 issued on Jan. 11, 2011, and entitled “A Field Emission System and Method”. The contents of this document are hereby incorporated herein by reference. A third generation of a correlated magnetic technology is described and enabled in the co-assigned U.S. patent application Ser. No. 12/476,952 filed on Jun. 2, 2009, and entitled “A Field Emission System and Method”. The contents of this document are hereby incorporated herein by reference. Another technology known as correlated inductance, which is related to correlated magnetics, has been described and enabled in the co-assigned U.S. Pat. No. 8,115,581 issued on Feb. 14, 2012, and entitled “A System and Method for Producing an Electric Pulse”. The contents of this document are hereby incorporated by reference.

Material presented herein may relate to and/or be implemented in conjunction with multilevel correlated magnetic systems and methods for producing a multilevel correlated magnetic system such as described in U.S. Pat. No. 7,982,568 issued Jul. 19, 2011 which is all incorporated herein by reference in its entirety. Material presented herein may relate to and/or be implemented in conjunction with energy generation systems and methods such as described in U.S. patent application Ser. No. 13/184,543 filed Jul. 17, 2011, which is all incorporated herein by reference in its entirety. Such systems and methods described in U.S. Pat. No. 7,681,256 issued Mar. 23, 2010, U.S. Pat. No. 7,750,781 issued Jul. 6, 2010, U.S. Pat. No. 7,755,462 issued Jul. 13, 2010, U.S. Pat. No. 7,812,698 issued Oct. 12, 2010, U.S. Pat. Nos. 7,817,002, 7,817,003, 7,817,004, 7,817,005, and 7,817,006 issued Oct. 19, 2010, U.S. Pat. No. 7,821,367 issued Oct. 26, 2010, U.S. Pat. Nos. 7,823,300 and 7,824,083 issued Nov. 2, 2011, U.S. Pat. No. 7,834,729 issued Nov. 16, 2011, U.S. Pat. No. 7,839,247 issued Nov. 23, 2010, U.S. Pat. Nos. 7,843,295, 7,843,296, and 7,843,297 issued Nov. 30, 2010, U.S. Pat. No. 7,893,803 issued Feb. 22, 2011, U.S. Pat. Nos. 7,956,711 and 7,956,712 issued Jun. 7, 2011, U.S. Pat. Nos. 7,958,575, 7,961,068 and 7,961,069 issued Jun. 14, 2011, U.S. Pat. No. 7,963,818 issued Jun. 21, 2011, and U.S. Pat. Nos. 8,015,752 and 8,016,330 issued Sep. 13, 2011, and U.S. Pat. No. 8,035,260 issued Oct. 11, 2011 are all incorporated by reference herein in their entirety.

The material presented herein may relate to and/or be implemented in conjunction with what is disclosed in U.S. Pat. No. 8,576,036 issued Nov. 5, 2013, U.S. Pat. No. 8,917,154 issued Dec. 23, 2014, U.S. Pat. No. 8,937,521 issued Jan. 20, 2015, U.S. Pat. No. 9,202,615 Issued Dec. 1, 2015, Provisional Application No. 61/640,979, filed May 1, 2012 titled “System for detaching a magnetic structure from a ferromagnetic material”, Non-provisional application Ser. No. 13/960,651 filed Feb. 27, 2013 titled “Magnetic Attachment System Having a Multi-Pole Magnetic Structure and Pole Pieces”, and Non-provisional application Ser. No. 14/198,416 filed Mar. 5, 2014 titled “Method and Making and Using Magnetic Structures in Semi-Flexible Material”. All of these are incorporated by reference herein in their entirety.

### Magnetic Attachment System:

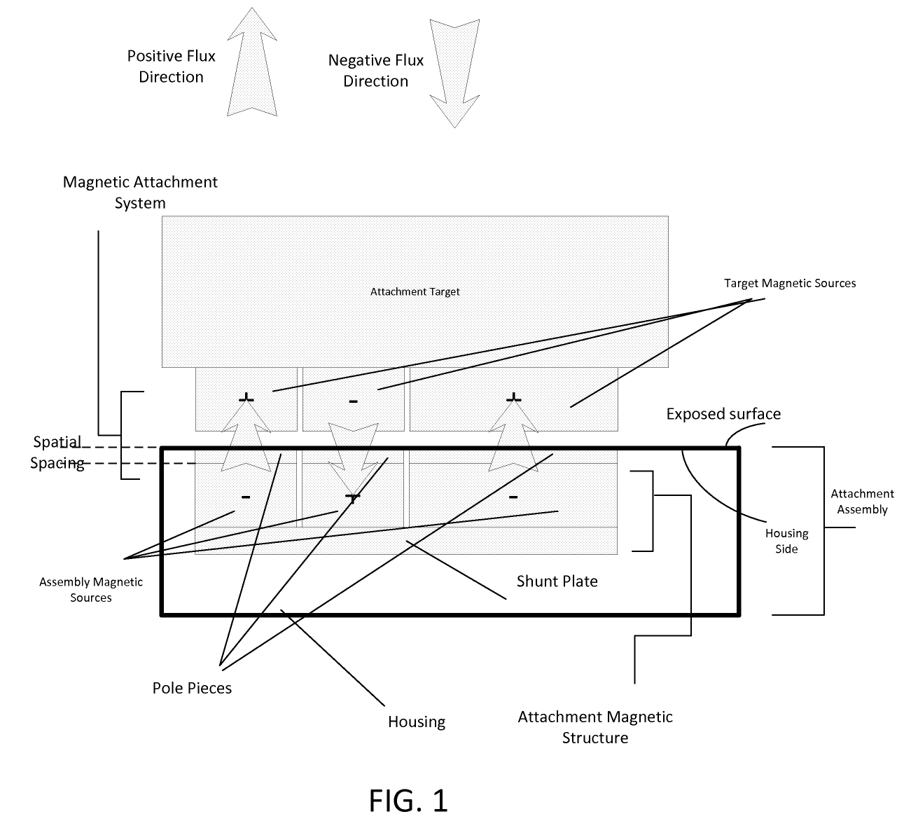

FIG. 1 depicts an exploded view of a magnetic attachment system in accordance with one aspect of the invention. The depicted magnetic attachment system can be used for attaching an attachment assembly comprising a housing having a housing side with an exposed surface that attaches to an attachment target. The attachment assembly comprises a magnetic structure (shown as attachment magnetic structure) positioned within the housing. The magnetic structure comprises a plurality of assembly magnetic sources positioned adjacent to each other. Such magnetic sources can be discrete magnetic sources, for example, any type of permanent magnet. In other embodiments, the magnetic sources can be printed onto a magnetizable material, as further described below. A plurality of pole pieces are coupled to the magnetic structure such that a spacing is created between the magnetic structure and the housing side. Each pole piece is coupled to a corresponding one of the plurality of field emission sources for directing magnetic flux. Similarly, the attachment target comprises a plurality of target magnetic sources that are complementary to the attachment magnetic sources, as further described below. In essence, the magnetic attachment system comprises a field emission system having a first field emission structure comprising the attachment magnetic structure and a second field emission structure comprising the attachment target.

The magnetic structure shown in FIG. 1 comprises a magnetic source of one polarity, e.g., positive (+), positioned between two attachment magnetic sources of opposite polarity, negative (−). As shown, this arrangement forms an attachment polarity pattern that presents a magnetic field opposite a complementary target polarity pattern formed by the target magnetic sources of the attachment target. As herein defined, a magnetic polarity is related to a flux direction between opposite polarity poles of magnetic sources. Conventionally, a magnetic source has a south pole and a north pole, where the flux direction can be either from the north pole to the south pole representing one polarity or from the south pole to the north pole representing the opposite polarity. FIG. 1 shows a positive (+) polarity with an up arrow and a negative (−) polarity with a down arrow. Thus, each one of the magnetic structure and the attachment target comprises an array of field emission sources, each having positions and polarities. As further described below, such positions and polarities relate to a spatial force function that corresponds to the relative alignment of the attachment magnetic structure and the attachment target within a field domain.

As shown in FIG. 1, each one of the plurality of the attachment magnetic sources is coupled to a corresponding pole piece such that a magnetic flux associated with an attachment magnetic source is directed via the corresponding pole piece to the attachment target. The pole piece coupling can be provided by fixedly attaching, e.g., bonding, each pole piece to a corresponding magnetic source such that the pole pieces move with the magnetic structure for attaching to the attachment target. The pole pieces can be physically distinct or discrete from each other at positions in which adjacent attachment magnetic sources have different polarities. As such, each pole piece can be contiguous at locations in which its corresponding magnetic sources have the same polarity. The pole pieces can be, for example, steel bars separated by a non-magnetic material (e.g., copper, aluminum, air, plastic).

As stated above, the attachment target itself comprises a magnetic structure having a plurality of target magnetic sources having a target polarity pattern that presents a magnetic field to the opposing attachment magnetic sources. Under this arrangement, similar to the attachment magnetic structure, the attachment target comprises a target magnetic source of negative (−) polarity, positioned between two target magnetic sources of positive (+) polarity. When the pole pieces and the magnetic sources of the magnetic structure are properly aligned with the target magnetic sources of the attachment target, an attachment spatial force is produced by magnetic flux directed via the pole pieces between the magnetic structure and the attachment target. This attachment spatial force is due to the correlation properties of the complementary attachment and target polarity patterns in proper alignment, as further described below.

### Coded Magnetic Pattern:

The attachment magnetic sources of the magnetic attachment structure and the attachment target can be arranged in any desired pattern. The attachment spatial force function is in accordance with a code that defines a peak spatial force corresponding to an alignment position of the magnetic structure and the attachment target and a plurality of off peak spatial forces corresponding to a plurality of different misalignments of the magnetic structure and the attachment target. In one embodiment, the attachment and target magnetic sources are arranged according to a Barker code. As is well known, Barker codes are unique binary sequences of fixed length N (e.g., 3, 4, 5, 7, 11, and 13, etc.) with unique autocorrelation properties. For example, Barker 4 is a binary sequence of four elements, i.e., a modulo 4 code, whereas Barker 7 is a binary sequence of 7 elements, i.e., a modulo 7 code, and so on. Under this configuration, the attachment and target magnetic sources of the attachment target can be arranged according to a complementary code.

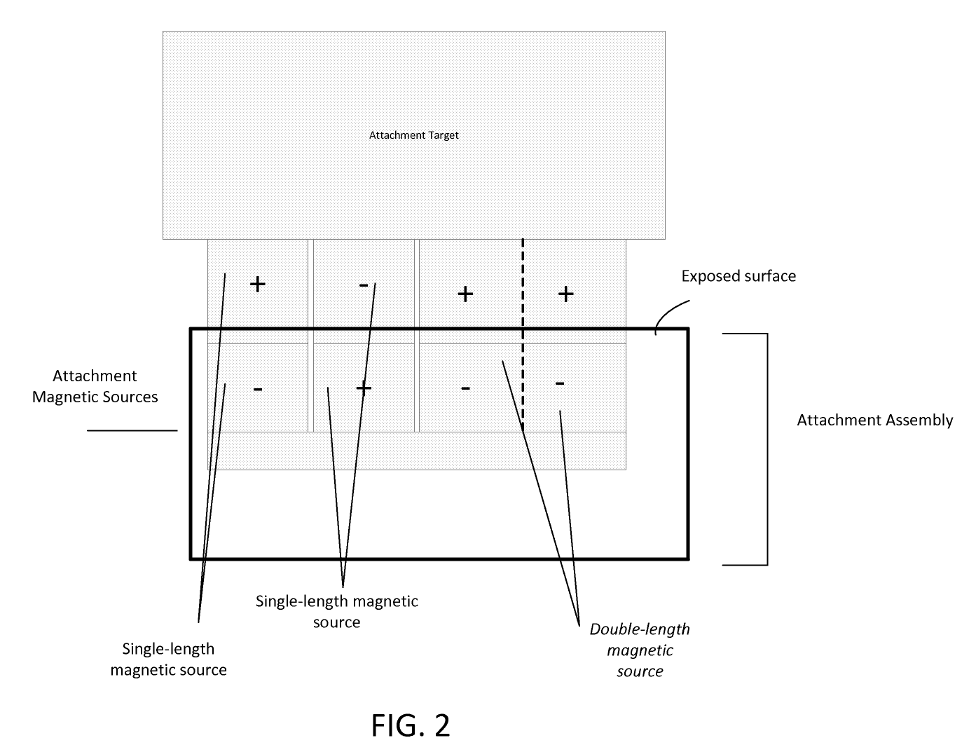

FIG. 2 shows the magnetic structure attached to the target as a result of the attachment spatial force created by magnetic flux that is directed therebetween via the pole pieces. As shown, adjacent magnetic sources of the attachment magnetic structure comprise a magnetic source of positive (+) polarity positioned between two attachment magnetic sources of negative polarity (−), where the length of one negative-polarity attachment magnetic source (shown with two −− signs separated by a dotted line) is twice or double the length of the other negative-polarity attachment magnetic source (shown with a single − sign). Under this arrangement, the polarities of the attachment magnetic sources corresponds to the Barker 4 code, which has a sequence corresponding to −+−− pattern, where the two adjacent negative − polarities are implemented with a single negative-polarity magnetic source having double the length of the other single attachment magnetic sources in the sequence. As such, the Barker 4 code is implemented using a single-length negative polarity magnetic source, a single length positive polarity source, and a double-length negative polarity source. Similarly, the magnetic sources of the attachment target implement a Barker 4 code, with two polarity reversals: one between the single-length positive polarity target magnetic source and the single-length negative polarity target magnetic source, and another between the single-length negative polarity target magnetic source and the double-length positive polarity target magnetic source. It is understood that any N adjacent magnetic sources of the same polarity can be implemented with a single polarity magnetic source of length N.

For directing magnetic flux between the magnetic structure and the attachment target, the pole pieces associated with corresponding magnetic sources of the magnetic structure can be arranged in such a way that they are physically separated from each other at locations of polarity reversal within the magnetic structure. In this way, a double-length pole piece can be used in conjunction with a double-length magnetic source, and similarly a pole piece of length N can be used in conjunction with a magnetic source of length N. Alternatively, multiple smaller pole pieces can be used for directing flux between corresponding magnetic sources, which can arranged in accordance with the number of opposing magnetic source areas, for example, four areas corresponding to a Barker 4 code, where each area could have its own pole piece.

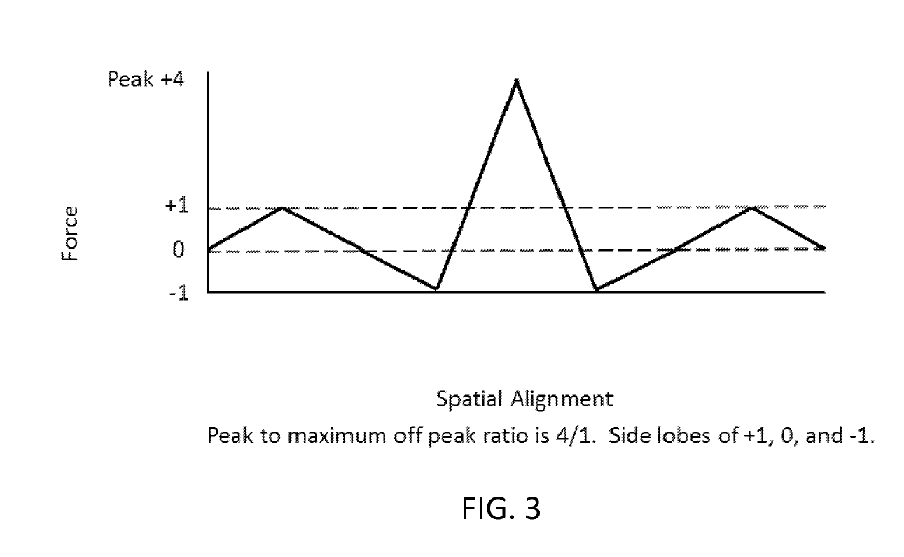

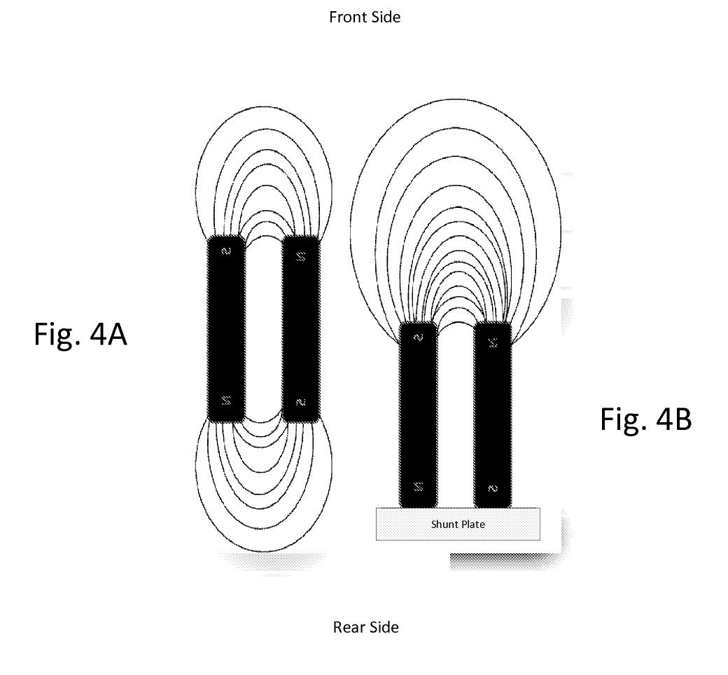

The attachment magnetic structure and the attachment target engage each other via a peak attachment spatial force produced by the autocorrelation properties of the complementary Barker 4 codes when the attachment and target magnetic sources are aligned with each other as shown in FIG. 2. FIG. 3 shows a peak attachment spatial force and off-peak spatial forces produced by such alignment when the complementary magnetic sources of the attachment magnetic structure and attachment target face each other separated by corresponding pole pieces which direct flux between corresponding magnetic sources. As can be seen, the code defines a peak spatial force corresponding to substantial alignment of a code modulo (modulo 4 for Barker 4) of the magnetic structure with the code modulo (4) of the attachment target, where the code also defines a plurality of off peak spatial forces corresponding to a plurality of different misalignments of the code modulo of the magnetic structure and the code modulo of the attachment target. As can be seen from FIG. 4, the plurality of off peak spatial forces have a largest off peak spatial force that is less than half of the peak spatial force.

The codes of the magnetic attachment device and attachment target can be of any configuration, for example 1 dimensional, 2 dimensional, square, rectangular, triangular, circular, or any other shape or configuration as desired. The codes of the magnetic attachment device and attachment target can be modified to induce desired behaviors, for example attraction, repulsion, centering, hovering, triggering, sorting, and lock-and-key behavior.

### Shunt Plate:

The attachment magnetic structure shown in FIGS. 1 and 2 can optionally include a shunt plate. FIGS. 4A-4B show how a shunt plate impacts magnetic fields of a pair of adjacent magnetic sources that have adjacent poles with opposite polarities next to each other. FIG. 4A shows the pair of adjacent magnetic sources without a shunt plate producing flux paths between the opposite polarities on both rear and front sides. FIG. 4B shows the magnetic fields produced after a shunt plate is added to the rear side. As can be seen, with the shunt plate, the rear field is substantially reduced, and portion of the flux from the rear field is directed through the magnetic material and out of the front side of the magnetic sources. A suitable shunt can result in a significant increase in the force available from a small amount of magnetic material used. Additionally, a shunt plate can make the forward projection of the Barker pattern shown in FIGS. 2 and 3 (or any other code) more clearly defined with less interference from the return field. As can be seen, the plurality of assembly field emission sources have opposing sides. The plurality of assembly pole pieces are coupled to one side and the shunt plate is coupled to the other side.

### Tablet Computer Example:

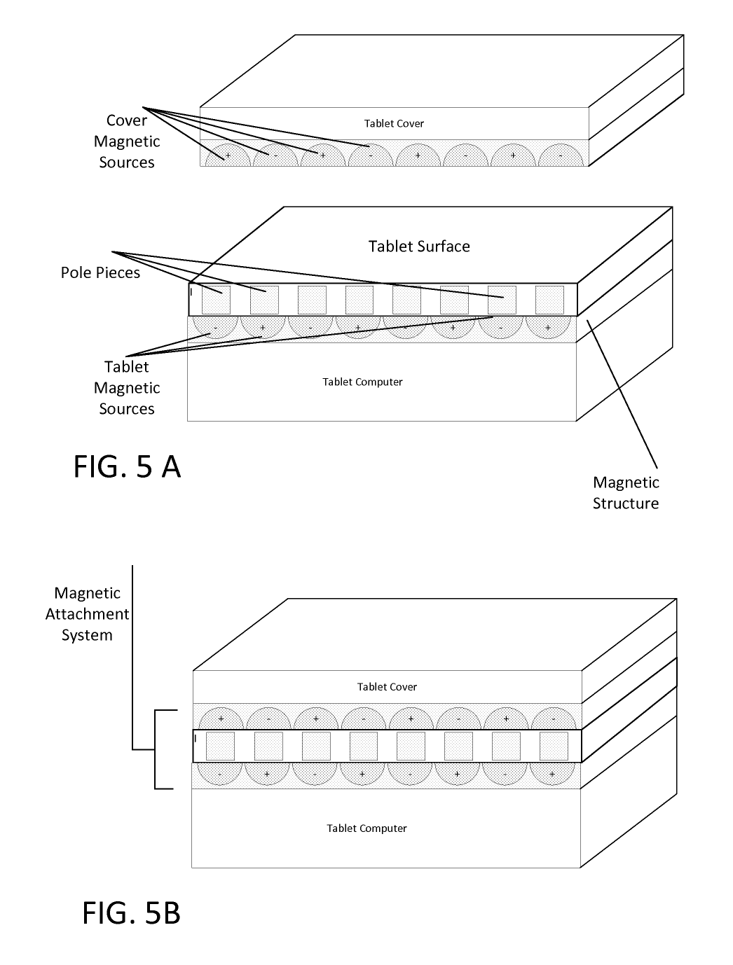

FIGS. 5A-5B shows the magnetic attachment system of the present invention being used to attach a tablet computer to a tablet cover attachment target to reduce the ambient magnetic fields on the surface of the tablet. As can be seen, pole pieces are placed on top of magnetic sources of the magnetic structure positioned within the tablet to direct magnetic flux to complementary target magnetic sources within the cover. FIG. 5A shows the table and cover detached from each other where a low magnetic field is created on the surface of the tablet due to the spacing or spatial separation created by the pole pieces between the tablet magnetic sources and the tablet surface. FIG. 5B shows the tablet cover attached to the tablet due to the peak spatial force created based on the autocorrelation properties of the codes corresponding to polarities and positions of the tablet magnetic sources and cover magnetic sources.

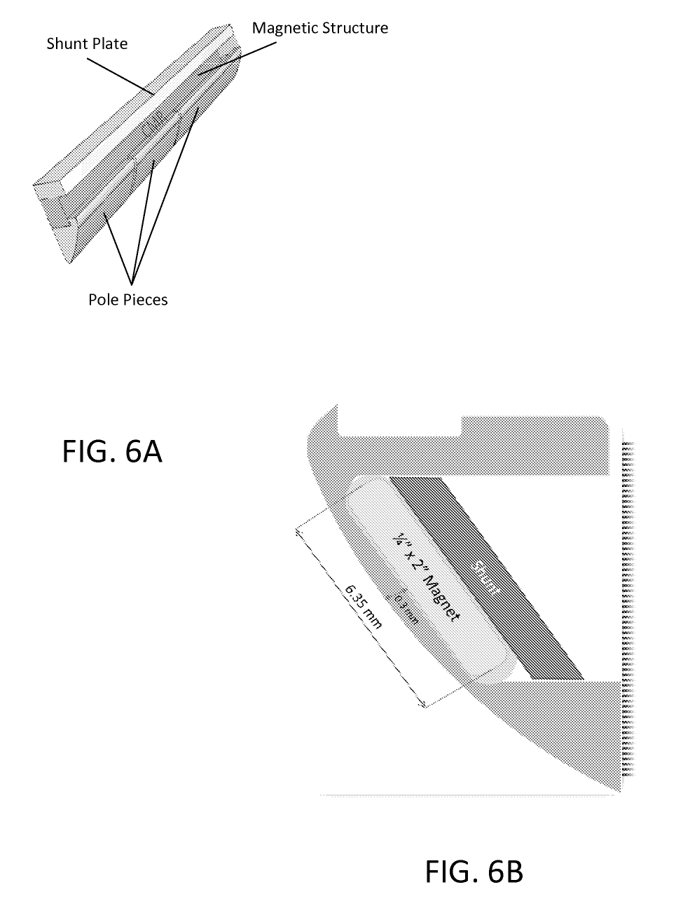

Because the pole pieces can be arranged in any shape, as desired, the attachment system of the present invention can be applied in a wide variety of attachment applications. FIGS. 6A-6B show two embodiments of the magnetic attachment device in which the pole pieces are shaped to fit within the case of the tablet computer. FIG. 6A shows an attachment assembly that comprises the magnetic structure with pole pieces shaped to fit inside the tablet housing shown in FIG. 6B, optionally, as a separate structure. The attachment assembly preferably includes a shunt plate that concentrates the magnetic flux through the magnetic structure in front of the pole pieces, which provide spatial separation between the magnetic structure and the tablet surface causing a low magnetic field to be created on the tablet surface when the cover attachment target is not attached. When the cover magnetic sources are properly aligned with the corresponding tablet magnetic sources, the created peak spatial force (shown in FIG. 3), which is created by the concentrated magnetic field and directed by the pole pieces securely attaches the cover to the tablet.

It would be appreciated that when the cover is not attached, the ambient magnetic field exposure is reduced on the tablet surface due to spatial separation created by the pole pieces. This arrangement eliminates the need to move magnets away from the tablet surface, for example, via a moving part such as a spring of prior art. Instead, the present invention simplifies the attachment assembly without requiring moving parts. It is understood that the above described tablet cover embodiments is just one application of the attachment system of the present invention and the present invention can be used in other applications that require reducing ambient magnetic field exposure.

### Printed Magnetic Structure:

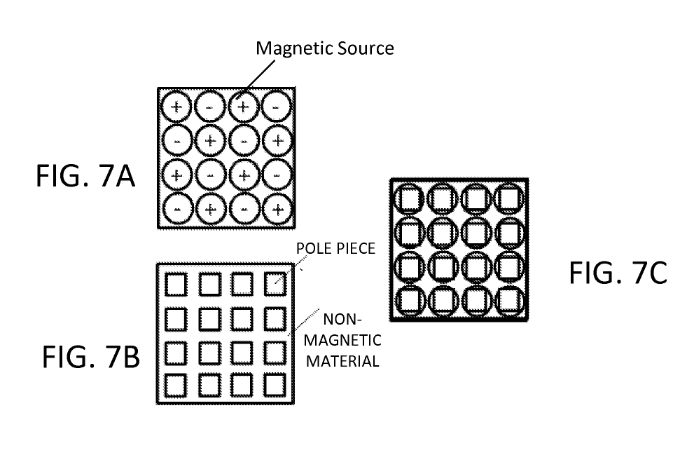

FIGS. 7A-7C shows the magnetic structure in one embodiment of the attachment system of the invention using a printed magnetic structure. FIG. 7A shows a multi-pole magnetic structure having a plurality of magnetic sources printed on a single piece of magnetizable material. Each printed magnetic source is referred to herein as a maxel. The printed magnetic structure shown in FIG. 7A has a pattern of adjacent magnetic sources having alternating polarities, forming a so called “checkerboard maxel pattern.” FIG. 7B shows a non-magnetic material having pole pieces comprising iron pieces arranged to match the checkerboard maxel pattern of FIG. 7A such that each maxel in the pattern is aligned with a corresponding pole piece, as shown in FIG. 7C. It would be appreciated that any desired printed magnetic pattern can be used with corresponding pole pieces.

### Layered Pole Pieces:

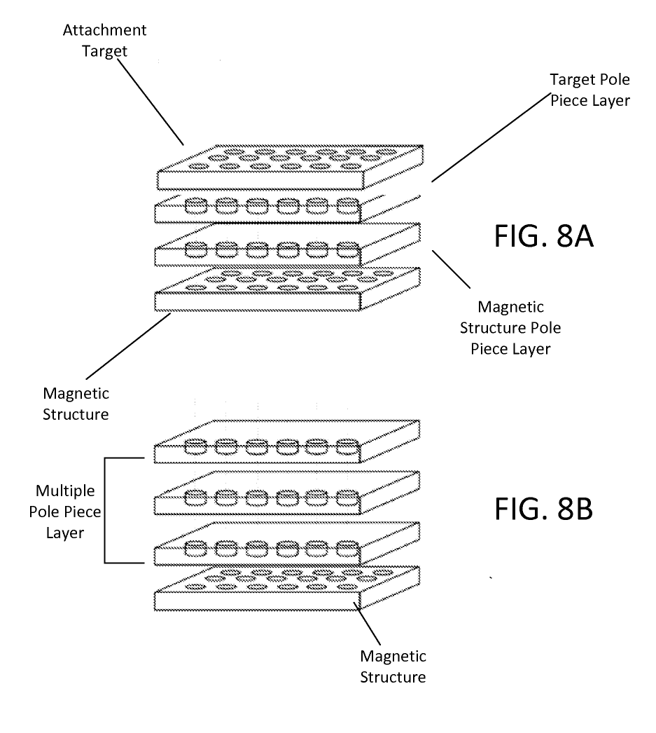

FIGS. 8A-8B depict layering pole pieces on top of the magnetic structure of the attachment system of the present invention. FIG. 8A shows a first pole piece layer, for example, comprising iron bars or pieces embedded in a binding substrate, remaining aligned with the magnetic sources of a magnetic structure. Similarly a second pole piece layer can be attached to the attachment target aligned with the target magnetic sources, thereby creating a two-layer pole piece arrangement for one embodiment of the attachment system of the present invention. FIG. 8B shows multiple pole piece layers with pole pieces in each layer being aligned with the magnetic sources of the magnetic structure. Similarly, multiple pole piece layers can be used with the attachment target. The attachment system can thus comprise one or more pole piece layers on either the magnetic structure, the attachment target or both.

While particular embodiments of the invention have been described, it will be understood, however, that the invention is not limited thereto, since modifications may be made by those skilled in the art, particularly in light of the foregoing teachings.

1. A method for assembling a magnetic attachment mechanism, said method comprising:
arranging a plurality magnetic field sources, each magnetic field source comprised of permanent magnet material, said plurality of magnetic field sources further comprising more than three magnetic polarity regions, wherein an arrangement of magnetic field sources comprises a polarity pattern having a respective autocorrelation function characterized by a plurality of alignment positions of said plurality of magnetic field sources, said plurality of alignment positions comprising a peak attract force alignment position and a plurality of off-peak force alignment positions, wherein a peak attract force is produced at the peak attract force alignment position, and wherein a plurality of off-peak attract forces are produced at said plurality of off-peak alignment positions, and wherein one or more of said plurality of off-peak attract forces are the result of a partial cancellation of an attract force by a repel force.

2. The method of claim 1, wherein the magnitude of said peak force is more than twice the magnitude of any off-peak attract force.

3. The method of claim 1, wherein the magnitude of said peak attractive force is less than or equal to twice the magnitude of any off-peak attract force.

4. The method of claim 1, wherein said plurality of off-peak forces further comprises a plurality of off-peak repel forces.

5. The method of claim 4, wherein the magnitude of said peak attract force is less than twice the magnitude of any off-peak repel force.

6. The method of claim 1 or 5, further comprising a non-magnetic region between two magnetic polarity regions.

7. The method of claim 6, wherein said non-magnetic region comprises a ferromagnetic material.

8. The method of claim 6, wherein said two magnetic polarity regions comprise the same polarity.

9. The method of claim 5, further comprising the step of enclosing said magnetic attachment mechanism in a non-ferromagnetic compartment.

10. The method of claim 2, further comprising the step of attaching said plurality of magnetic field sources to a substantially linear piece of ferromagnetic material.

11. The method of claim 9, further comprising the step of affixing a ferromagnetic pole piece to each of said plurality of magnetic field sources, each of said ferromagnetic pole pieces being separated from one another by a non-magnetic region, such that said polarity pattern of said magnetic field sources is routed to a surface of said pole pieces.

12. A method for assembling a magnetic attachment mechanism, said method comprising:
Affixing to a holding structure a first portion of a first magnetizable material having a first alternating polarity pattern; and a second portion of said first magnetizable material having a second alternating polarity pattern, wherein said first magnetizable material is configured to be capable of producing magnetic forces when said first magnetizable material is aligned with a second magnetizable material, said magnetic forces comprising a repel force curve and a first attract force curve that combine to produce a composite force curve that is a second attract force curve, wherein said second attract force curve further comprises an inflection point, wherein said first attract force curve has a first peak attract force and said second attract force curve has a second peak attract force that is less than said first peak attract force, wherein said first magnetizable material is configured to be moveable relative to said second magnetizable material in at least two dimensions when in a first portion of said composite force curve.

13. The method of claim 10, wherein said first magnetizable material is movable relative to said second magnetizable material in only one dimension when in a second portion of said composite force curve.

14. The method of claim 11, wherein said first magnetizable material comprises an asymmetric polarity pattern.

15. The method of claim 10, wherein said inflection point comprises a transition from an increasing attract force to a decreasing attract force.

16. A method of assembling a magnetic attachment mechanism, said method comprising:
Affixing to a holding structure a first plurality of magnetic field sources, each magnetic field source comprised of permanent magnet material, said first plurality of magnetic field sources further comprising three or more alternating magnetic polarity regions, said first plurality of magnetic field sources further comprising a polarity pattern, said polarity pattern having a respective autocorrelation function characterized by a plurality of alignment positions of said first plurality of magnetic field sources, said plurality of alignment positions comprising a peak attract force alignment position and a plurality of off-peak force alignment positions, wherein a peak attract force is produced at the peak attract force alignment position, and wherein a plurality of off-peak attract forces are produced at said plurality of off-peak alignment positions, and wherein one or more of said plurality of off-peak attract forces are the result of a partial cancellation of an attract force by a repel force, and wherein said first plurality of magnetic field sources is configured to be capable of producing magnetic forces when said first plurality of magnetic field sources is aligned with a second plurality of magnetic field sources, said magnetic forces comprising a repel force curve and a first attract force curve that combine to produce a composite force curve that is a second attract force curve, wherein said second attract force curve further comprises an inflection point, wherein said first attract force curve has a first peak attract force and said second attract force curve has a second peak attract force that is less than said first peak attract force, wherein said first plurality of magnetic field sources is configured to be moveable relative to said second plurality of magnetic field sources in at least two dimensions when in a first portion of said composite force curve.
